(19) United States
(12) Patent Application Publication
(10) Pub. No.: US 2017/0044398 A1
(43) Pub. Date: Feb. 16, 2017

(54) COLLOIDS CONTAINING POLYARAMIDE

(71) Applicants: Mary PARENT, Mountain View, CA (US); Light Polymers Holding, George Town (KY)

(72) Inventors: Mary PARENT, Mountain View, CA (US); Joseph Marc MCCONNAUGHEY, Temecula, CA (US); Chih-Hao HUANG, New Taipei City (CN); Chia Jung CHANG, New Taipei City (CN)

(21) Appl. No.: 15/306,541

(22) PCT Filed: Apr. 24, 2015
(86) PCT No.: PCT/US2015/027546

§ 371 Date: Oct. 25, 2016

Related U.S. Application Data
(60) Provisional application No. 61/984,751, filed on Apr. 26, 2014.

(51) Int. Cl. C09D 177/10; C09D 5/22; C09K 11/02; C09D 7/12; C08G 69/32; C09K 11/77; C09K 11/88; C09D 5/24; C08J 5/18

(52) U.S. Cl. CPC C09D 177/10; C09D 5/24; C09D 5/22; C09K 11/02; C08J 5/18; C08G 69/32; C09K 11/025; C09K 11/7706; C09K 11/883; C09D 7/125; C08K 7/06

(57) ABSTRACT

Colloids include a polyaramide and conductive materials, wavelength-converting materials, and/or light diffusing material. The colloid can be coated and optionally aligned on a substrate to form a film, and the film can be removed from the substrate to form a standalone film.

### CONTINUING APPLICATION DATA

This application claims the benefit of U.S. Provisional Application Ser. No. 61/984,751, filed Apr. 26, 2014, which is incorporated by reference herein.

### BACKGROUND

Films including conductive materials, including conductive micro- and nano-spheres, rods, flakes, wires, sheets, etc., can be used in variety of applications, for example anti-static coatings, sensors, touch screens, electromagnetic interference (EMI) or radio-frequency interference (RFI) shielding, and electrodes for optoelectronic devices. During manufacturing of such films, poor suspension stability of conductive materials causes the loss of conductive materials and non-uniform coatings and overall deterioration of the performance.

Poor suspension stability during manufacturing of films containing wavelength-converting material and light diffusing material can cause agglomerations and results in inhomogeneous distribution of the particles within the films. These agglomerations can decrease quantum efficiency of optical conversion, irregularly affect angular diffusive characteristics, and create non-uniformities in light output including, for example, hot spots or mura.

### SUMMARY OF THE INVENTION

The present disclosure relates to colloids that include a dispersion medium including polyaramides and a dispersed phase including conductive materials, wavelength-converting materials, and/or light diffusing materials. The colloids can be used to form coatings, films, or shapes that can be used for, for example, touch screens; EMI shields for use in architectural coatings such as window films; electrodes for organic light-emitting diodes (OLEDs), and solar cells. Other applications include, but are not limited to, management of color and spatial characteristics of light, for example in lighting; remote phosphor optical elements; hybrid films, comprising phosphors and quantum dots; and diffusers as found, for example, in the backlight of a display.

The present disclosure relates to colloids that include a dispersion medium including a polyaramide. The polyaramide can include

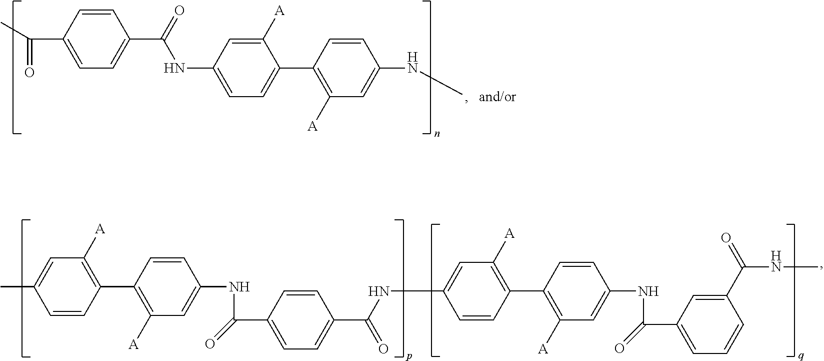

wherein A is independently selected from SO₃H or COOH, or a sulfonic or carboxy salt of an alkali metal, ammonium, quaternary ammonium, alkali earth metal, Al³⁺, La³⁺, Ce³⁺, Fe³⁺, Cr³⁺, Mn²⁺, Cu²⁺, Zn²⁺, Pb²⁺ or Sn²⁺; n is an integer between 2 and 10,000; p is an integer greater than or equal to 1; and q is an integer greater than or equal to 1. The colloids further include a dispersed phase that includes conductive materials, wavelength-converting materials, and/or light diffusing materials. These colloids can be used to form films which, in many embodiments, have superior qualities due to the properties of the claimed polyaramides.

Also disclosed are methods of forming a colloid layer on a substrate, where the colloid includes a dispersion medium and a dispersed phase. The dispersion medium includes a polyaramide. The polyaramide can include

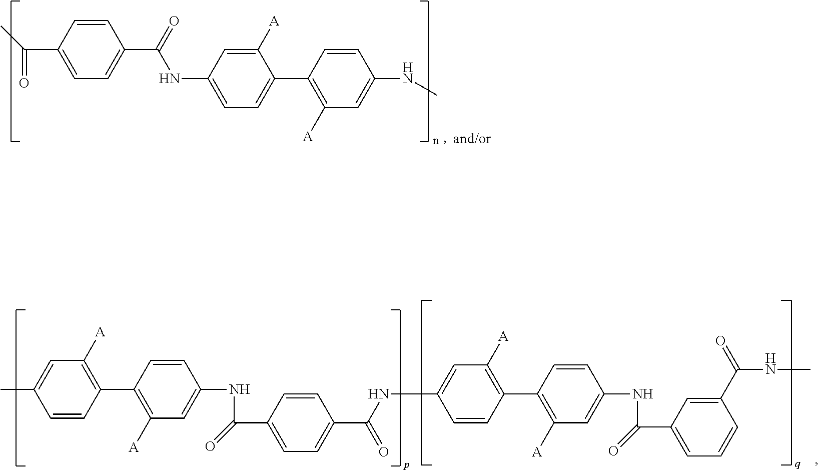

wherein A is independently selected from SO₃H or COOH, or a sulfonic or carboxy salt of an alkali metal, ammonium, quaternary ammonium, alkali earth metal, Al³⁺, La³⁺, Ce³⁺, Fe³⁺, Cr³⁺, Mn²⁺, Cu²⁺, Zn²⁺, Pb²⁺ or Sn²⁺; n is an integer between 2 and 10,000; p is an integer greater than or equal to 1; and q is an integer greater than or equal to 1. The dispersed phase includes conductive materials, wavelength-converting materials, and/or light diffusing materials.

The above summary of the present invention is not intended to describe each disclosed embodiment or every implementation of the present invention. The description that follows more particularly exemplifies illustrative embodiments. In several places throughout the application, guidance is provided through examples, which examples can be used in various combinations. In each instance of a list, the recited list serves only as a representative group and should not be interpreted as an exclusive list.

### BRIEF DESCRIPTION OF THE FIGURES

The disclosure may be more completely understood in consideration of the following detailed description of various embodiments of the disclosure in connection with the accompanying drawings; in which:

FIG. 1A shows a film formed on a glass substrate by spin coating a solution including poly(2,2′-disulfo-4,4′-benzidine terephthalamide) and silver nanowires. (400× magnification). The silver nanowires (dispersed phase) are distributed in poly(2,2′-disulfo-4,4′-benzidine terephthalamide) (dispersion medium). FIG. 1B shows a film formed on a glass substrate by coating a solution including poly(2,2′-disulfo-4,4′-benzidine terephthalamide) (13.6% in water) and silver nanowires (1% in water) in a 1:2 weight ratio with a bar applicator. (400× magnification) The arrow indicates the direction of coating. The silver nanowires (dispersed phase) are oriented within poly(2,2′-disulfo-4,4′-benzidine terephthalamide) (dispersion medium). The images of FIG. 1A and FIG. 1B were collected using a transmitted light microscopy; the silver nanowires appear as darker areas or lines, and the dispersion medium as lighter areas.

FIG. 2 shows the film thickness and color temperature at 467 nm excitation of films formed from colloids including phosphor and poly(2,2′-disulfo-4,4′-benzidine terephthalamide-isophthalamide) and coated on cellulose triacetate film (TAC).

FIG. 3 shows the percent haze and percent transmittance versus film thickness for films formed at two different spray pressures from colloids including poly(2,2′-disulfo-4,4′-benzidine terephthalamide) and fumed silica particles and coated on poly(methyl methacrylate) (PMMA).

FIG. 4 shows the variation of viscosity of a solution of poly(2,2′-disulfo-4,4′-benzidine terephthalamide-isophthalamide) in water with varying solids content as a function of temperature. The viscosity was measured at constant shear stress of 5 Pa (shear rates 0.01-40 l/s).

FIG. 5 shows the variation of viscosity of solutions of poly(2,2′-disulfo-4,4′-benzidine terephthalamide-isophthalamide) in water with varying solids content and temperatures as a function of shear rate.

FIG. 6 shows the variation of viscosity of a solution of poly(2,2′-disulfo-4,4′-benzidine terephthalamide) in water with varying solids content and temperatures as a function of shear rate.

FIG. 7 shows the variation of viscosity of a solution of poly(2,2′-disulfo-4,4′-benzidine terephthalamide-isophthalamide) in water as a result of varying total solids content and varying the amount of a polymer additive containing polyester, as a function of shear rate.

FIG. 8 shows the refractive index versus wavelength for poly(2,2′-disulfo-4,4′-benzidine terephthalamide-isophthalamide).

### DETAILED DESCRIPTION OF ILLUSTRATIVE EMBODIMENTS

The present disclosure relates to colloids including a dispersion medium including a polyaramide including

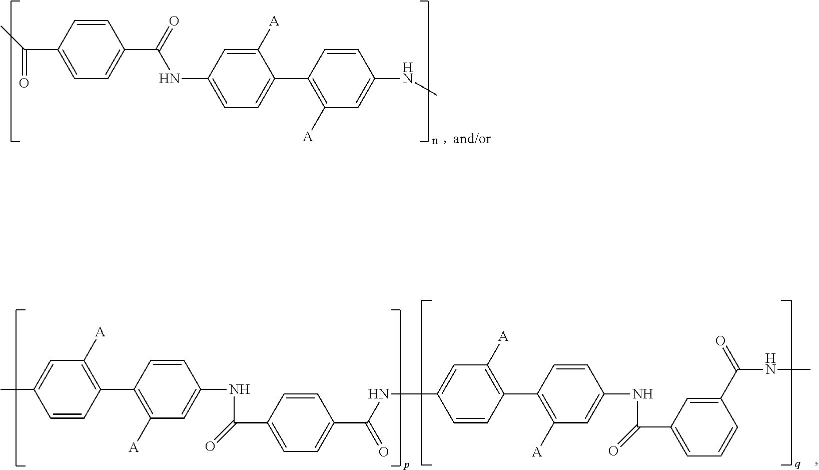

wherein A is independently selected from SO₃H or COOH, or a sulfonic or carboxy salt of an alkali metal, ammonium, quaternary ammonium, alkali earth metal, Al³⁺, La³⁺, Ce³⁺, Fe³⁺, Cr³⁺, Mn²⁺, Cu²⁺, Zn²⁺, Pb²⁺ or Sn²⁺; n is an integer between 2 and 10,000; p is an integer greater than or equal to 1; and q is an integer greater than or equal to 1; and a dispersed phase comprising a conductive material, a wavelength-converting material, and/or light diffusing materials.

The claimed polyaramides can decrease agglomeration and sedimentation of the dispersed phase due to intrinsic balance of hydrophilic-hydrophobic interactions within the material for wide ranges of solids content.

The claimed colloids can be used to form films, providing advantages over other films containing conductive materials, wavelength-converting materials, and/or light diffusing materials. For example, the claimed polyaramides may increase uniformity in suspended conductive materials during film formation. Such increased uniformity allows for the use of lower amounts of conductive materials while maintaining electric conductivity at the same level. The claimed polyaramides may also provide a mechanism for orientation of conductive materials within the colloid. The claimed polyaramides may provide enhanced temperature stability when compared to other polymers; they do not exhibit a glass transition and have high decomposition temperatures of up to 350° C., permitting an increased variety and number of processing steps for the films.

The claimed polyaramides may decrease agglomeration of wavelength-converting materials during film formation, allowing the formation of films with more uniform distribution of the dispersed phase. Additionally the claimed polyaramides can also be optically anisotropic and being disordered provide the films with diffusive properties, these diffusive properties give the films light-mixing functionality and result in more uniform light output, allowing the prevention of hot spots and mura. The claimed polyaramides can also have refractive indices that may match the refractive indices of wavelength-converting materials including, for example, phosphors and quantum dots. These matching refractive indices allow for decreased reflectance and back scattering. Additionally, the index matching and decreased agglomeration permit higher quantum conversion efficiency and luminous flux in phosphor-containing, quantum dot-containing, or hybrid films. The claimed polyaramides may also provide a mechanism for orientation of anisometric wavelength-converting materials within a colloid. The claimed polyaramides provide enhanced temperature stability when compared to other polymers, which is beneficial in down-conversion optical processes where an excess of optical energy releases as heat.

The claimed polyaramides may decrease agglomeration of light diffusing material during film formation, allowing the formation of films with more uniform distribution of the dispersed phase. The claimed polyaramides can have refractive indices that may contrast with the refractive indices of a light diffusing material, improving light diffusing capability. The claimed polyaramides can also be optically anisotropic and being disordered provide the films with additional soft diffusive properties, improving uniformity of light output and preventing hot spots and mura. The claimed polyaramides being optically anisotropic can form an optically anisotropic coating which, in many embodiments, has three different principal refractive indices. One of the refractive indices can match the refractive index of the dispersed phase, enabling polarization sensitive scattering functionality in the film. The claimed polyaramides may also provide a mechanism for orientation of anisometric diffusing particles within the colloid in order to change the aspect ratio of the scattering angular distribution. The claimed polyaramides may provide enhanced temperature stability when compared to other polymers because they do not exhibit a glass transition and have high decomposition temperatures of up to 350° C.

In this disclosure:

“Aqueous” refers to a material being soluble or dissolved in water at an amount of at least 1% wt or at least 10% wt of the material in water at 20 degrees Celsius and 1 atmosphere.

“Haze” refers to a light scattering value that is measured in the visible wavelength range, such as, for example, 400 nm to 700 nm, with a haze meter. Haze values can be measured using ASTM methods and commercially available haze meters from BKY Gardner Inc., USA, for example.

“Optical element” refers to any element that has an optical function, such as transmitting light, diffusing light, polarizing light, recycling light, and the like. The optical element can be made of glass, silicon, quartz, sapphire, plastic, and/or a polymer. The polymer can be, for example, poly(methyl methacrylate), polycarbonate, polystyrene, cyclic olefin copolymer, or amorphous polyolefin. The optical element can be in the form of a film, lens, sheet, plate, and the like.

“Refractive index” or “index of refraction” refers to the absolute refractive index of a material that is understood to be the ratio of the speed of electromagnetic radiation in free space to the speed of the radiation in that material. The refractive index of isotropic material can be measured using known methods and is generally measured using an Abbe refractometer in the visible light region (available commercially, for example, from Fisher Instruments of Pittsburgh, Pa.). Refractive indices of anisotropic materials can be measured in polarized light by analyzing the reflection spectrum as a function of the incident angle using the Fresnel formulae. It is generally appreciated that the measured index of refraction can vary to some extent depending on the instrument and the measurement setup.

The term “shear coating” includes coating a material with shear force applied to the coating material, such as, blade coating, microgravure coating, gravure coating, smooth roll coating, mayer rod coating, knife coating, slit-die coating, slot-die coating, comma coating, curtain coating, and the like, for example. Printing methods, such as, ink jet printing, flexographic printing, screen printing, and the like, and dip coating, spin coating, and spray coating methods, also apply shear force to the coating material.

“Visible light transmittance” refers to light transmission in the visible wavelength range of 400 nm to 700 nm. Light transmittance values can be measured using ASTM methods and commercially available light transmittance instruments.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

The terms “comprises” and variations thereof do not have a limiting meaning where these terms appear in the description and claims.

Unless otherwise specified, “a,” “an,” “the,” and “at least one” are used interchangeably and mean one or more than one.

Also herein, the recitations of numerical ranges by endpoints include all numbers subsumed within that range (e.g., 1 to 5 includes 1, 1.5, 2, 2.75, 3, 3.80, 4, 5, etc.).

For any method disclosed herein that includes discrete steps, the steps may be conducted in any feasible order. And, as appropriate, any combination of two or more steps may be conducted simultaneously.

### Colloids

A colloid is a substance that includes two or more phases. The first phase, the dispersed phase, is distributed in the second phase, the dispersion medium. In some embodiments, the dispersion medium is a solid. For example, the dispersion medium can include a polyaramide. In some embodiments, the dispersion medium is a liquid. For example, the dispersion medium can include a polyaramide in solution. In some embodiments, the dispersion medium is aqueous. The dispersed phase is a solid. For example, the dispersed phase can include a conductive material, a wavelength-converting material, and/or light diffusing material. The dispersion medium and/or the dispersed phase can include additional components including, for example, a polymer and/or a plasticizer. In some embodiments, the dispersion medium and/or the dispersed phase include polyester.

In some embodiments, the dispersed phase includes symmetrical materials including, for example, beads, spherical particles, etc. In some embodiments, the dispersed phase includes anisometric materials including, for example, wires, tubes, flakes, filaments, ribbons, non-spherical particles, particle fragments, etc.

In some embodiments, the dispersion medium and/or the dispersed phase of a colloid can include additional components including, for example, a polymer and/or a plasticizer. In some embodiments the polymer is water-soluble. In some embodiments where the polymer is water-soluble, the dispersion medium includes the polymer. The polymer may include, for example, polyester. In some embodiments, the polyester is a water-soluble polyester.

In one or more embodiments, a dispersion medium includes one or more polyaramides; the colloid further includes a polyester; and the weight/weight % of polyester to the polyaramide(s) is between 50 and 100, between 60 and 100, between 70 and 100, between 80 and 100, between 50 and 90, between 50 and 80, between 50 and 60, between 60 and 90, between 70 and 80, between 75 and 90, or between 75 and 80, where weight/weight % is calculated by dividing the weight of the polyester by the weight of the polyaramide(s).

In some embodiments, a colloid including a liquid dispersion medium including, for example, a polyaramide in solution, can be used to coat a substrate. After drying or removal of the liquid, the remaining colloid forms a solid dispersion medium, and the colloid can form a film. In one aspect, the film may be removed from the substrate to form a standalone film.

The substrate can be, for example, glass; a film, including for example, cellulose triacetate film (TAC); or a polymer, including, for example, polyethylene terephthalate (PET) or poly(methyl methacrylate) (PMMA). In some embodiments, the substrate is an optical element. The substrate may be pre-treated before coating. For example, the substrate may be corona treated, saponified, plasma treated, and/or primed with a primer.

In some embodiments, a coating can be formed by shear coating a colloid along a coating direction onto a substrate to form a colloid layer. In some embodiments where the coating is formed by shear coating and the dispersed phase includes an anisometric material, the anisometric material can be substantially aligned or parallel extending along the coating direction.

### Polyaramides

The dispersion medium includes one or more polyaramides. A polyaramide is an aromatic polyamide. In some conditions, the polyaramide may form an anisotropic or liquid crystal material. The polyaramides may be polymers, and/or lyotropic liquid crystals. Polymers can include, for example, copolymers and block copolymers.

The polyaramide can include

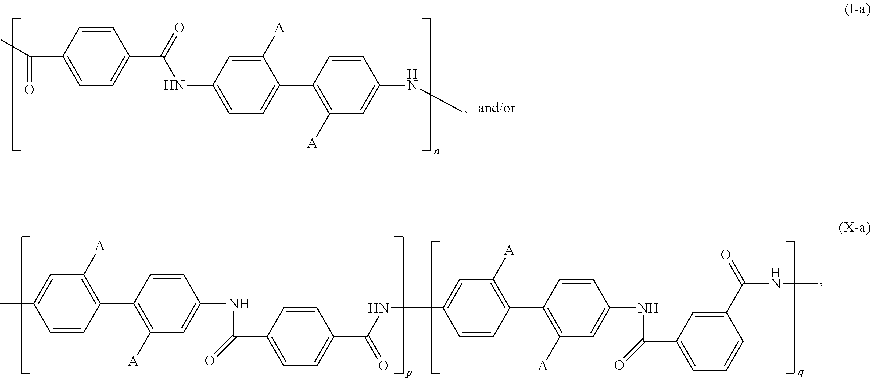

wherein A is independently selected from SO₃H or COOH, or a sulfonic or carboxy salt of an alkali metal, ammonium, quaternary ammonium, alkali earth metal, Al³⁺, La³⁺, Ce³⁺, Fe³⁺, Cr³⁺, Mn²⁺, Cu²⁺, Zn²⁺, Pb²⁺ or Sn²⁺; n is an integer between 2 and 10,000; p is an integer greater than or equal to 1; and q is an integer greater than or equal to 1. In one embodiment, A can be SO₃H and/or COOH, wherein 0%, 3%, 4%, 5%, 8%, 10%, 15%, 20%, 25%, 30%, 35%, 40%, 45%, 50%, 60%, 70%, 80%, 90%, 95%, or 100% of A is SO₃H or a sulfonic acid salt and 100%, 97%, 96%, 95%, 92%, 90%, 85%, 80%, 75%, 70%, 65%, 60%, 55%, 50%, 40%, 30%, 20%, 10%, 5%, or 0% of A is COOH or a carboxylic acid salt.

In some embodiments, the polyaramide includes

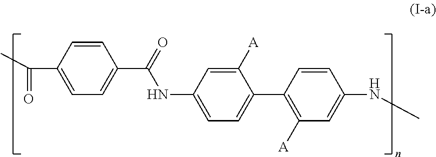

wherein A is independently selected from SO₃H or COOH, or a sulfonic or carboxy salt of an alkali metal, ammonium, quaternary ammonium, alkali earth metal, Al³⁺, La³⁺, Ce³⁺, Fe³⁺, Cr³⁺, Mn²⁺, Cu²⁺, Zn²⁺, Pb²⁺ or Sn²⁺, and wherein n is an integer between 2 and 10,000. In some embodiments, n is at least 5. In one embodiment, A can be SO₃H and/or COOH, wherein 0%, 3%, 4%, 5%, 8%, 10%, 15%, 20%, 25%, 30%, 35%, 40%, 45%, 50%, 60%, 70%, 80%, 90%, 95%, or 100% of A is SO₃H or a sulfonic acid salt and 100%, 97%, 96%, 95%, 92%, 90%, 85%, 80%, 75%, 70%, 65%, 60%, 55%, 50%, 40%, 30%, 20%, 10%, 5%, or 0% of A is COOH or a carboxylic acid salt.

In some embodiments, the polyaramide includes a compound or salt including

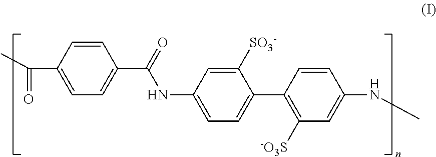

wherein n is an integer between 2 and 10,000. Examples of a synthesis of this molecule, poly(2,2′-disulfo-4,4,′-benzidine terephthalamide), are described in Example 12. In one embodiment, the average molecular weight is about 50,000 to about 150,000. In one embodiment, the number-average molecular weight is about 10,000 to about 150,000. In another embodiment, the number-average molecular weight is about 50,000 to about 150,000.

In some embodiments, the polyaramide includes

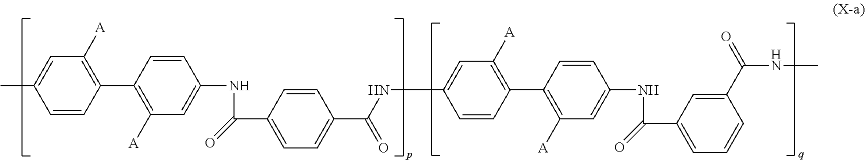

wherein A is independently selected from SO₃H or COOH, or a sulfonic or carboxy salt of an alkali metal, ammonium, quaternary ammonium, alkali earth metal, Al³⁺, La³⁺, Ce³⁺, Fe³⁺, Cr³⁺, Mn²⁺, Cu²⁺, Zn²⁺, Pb² or Sn²′; p is an integer greater than or equal to 1; and q is an integer greater than or equal to 1. In one embodiment, A can be SO₃H and/or COOH, wherein 0%, 3%, 4%, 5%, 8%, 10%, 15%, 20%, 25%, 30%, 35%, 40%, 45%, 50%, 60%, 70%, 80%, 90%, 95%, or 100% of A is SO₃H or a sulfonic acid salt and 100%, 97%, 96%, 95%, 92%, 90%, 85%, 80%, 75%, 70%, 65%, 60%, 55%, 50%, 40%, 30%, 20%, 10%, 5%, or 0% of A is COOH or a carboxylic acid salt.

In some embodiments, the polyaramide includes a copolymer including a segment including the following general formula:

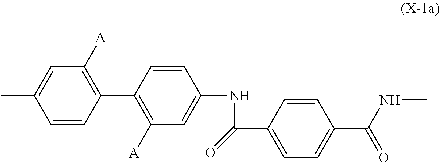

and a segment including the following general formula:

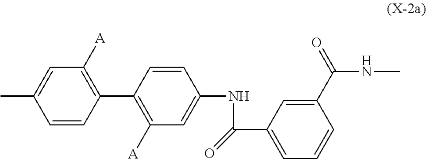

wherein A is independently selected from SO₃H or COOH, or a sulfonic or carboxy salt of an alkali metal, ammonium, quaternary ammonium, alkali earth metal, Al³⁺, La³⁺, Ce³⁺, Fe³⁺, Cr³⁺, Mn²⁺, Cu²⁺, Zn²⁺, Pb²⁺ or Sn²⁺; and wherein at least one segment of formula (X-1a) and one segment of formula (X-2a) are connected by a covalent bond. The polymer segment may include a single segment of formula (X-1a) bonded to a single segment of formula (X-2a) or mixed segments of formula (X-1a) and formula (X-2a). In one embodiment, A can be SO₃H and/or COOH, wherein 0%, 3%, 4%, 5%, 8%, 10%, 15%, 20%, 25%, 30%, 35%, 40%, 45%, 50%, 60%, 70%, 80%, 90%, 95%, or 100% of A is SO₃H or a sulfonic acid salt and 100%, 97%, 96%, 95%, 92%, 90%, 85%, 80%, 75%, 70%, 65%, 60%, 55%, 50%, 40%, 30%, 20%, 10%, 5%, or 0% of A is COOH or a carboxylic acid salt.

In some embodiments, the polyaramide includes a copolymer including a segment including the following formula:

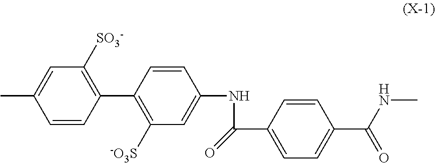

and a segment including the following formula:

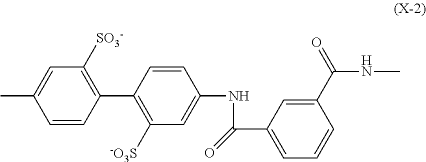

wherein at least one segment of formula (X-1) and one segment of formula (X-2) are connected by a covalent bond. The polymer segment may include a single segment of formula (X-1) bonded to a single segment of formula (X-2) or mixed segments of formula (X-1) and formula (X-2).

In some embodiments, the ratio of segments of formula (X-1) and/or (X-1a) to segments of formula (X-2) and/or (X-2a) is about 73:27. In other embodiments, the ratio of segments can be 0:100, 1:99, 5:95, 10:90, 15:85, 20:80, 25:75, 30:70, 35:65, 40:60, 45:55, 50:50, 55:45, 60:40, 65:35, 70:30, 75:25, 80:20, 85:15, 90:10, 95:5, 99:1, 100:0 or any ratio in between, or range of these ratios. In some embodiments, the number-average molecular weight can be between 2,000 and 50,000, between 2,000, and 10,000, or between 4,000 and 6,000, and the number-average molecular weight is about 5000. Examples of synthesis of a polymer including segments (X-1) and (X-2), 2,2′-disulfo-4,4′-benzidine terephthalamide-isophthalamide copolymer, represented by the following formula

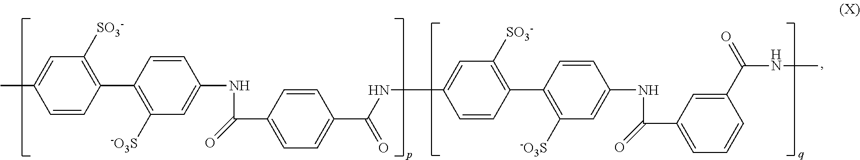

is described in Example 11.

### Conductive Material

In one or more embodiments, the dispersed phase includes a conductive material. The conductive material can include, for example, nanospheres, nanowires, nanotubes, microspheres, microwires, nanoflakes, microflakes, conductive polymers, etc.

In some embodiments, nanospheres and nanowires may range from 10 to 100 nm in diameter. In some embodiments, microspheres and microwires may range from 0.2 to 20 μm in diameter. Nanowires and microwires may have an aspect ratio between 100 and 5000. In some embodiments, nanoflakes and/or microflakes can be at least 50 nm, at least 0.1 μm, or at least 0.2 μm.

Nanospheres, nanowires, nanotubes, microspheres, microwires, etc., can include materials including, for example, gold, silver, copper, cobalt, nickel, graphene oxide, copper-nickel, cobalt-nickel, carbon (for example, carbon nanotubes), etc. Nanoflakes and microflakes can include materials including silver, copper, and graphene oxide.

Conductive polymers can include, for example, poly(3,4-ethylenedioxythiophene) (PEDOT), polyacetylene, polyphenylene vinylene, polypyrrole, polythiophene, polyaniline, and polyphenylene sulfide, etc.

A variety of shapes of conductive materials may be used depending on the intended use of the colloid or film formed from the colloid. In some embodiments, the aspect ratio of the conductive material is between 1 and 10,000. In other embodiments, the aspect ratio of the conductive material is between 100 and 5000. In some embodiments, materials with lower aspect ratios may be used for if colloids with lower resistance and global conductivity are desired, for example, to form films for touch panel displays. In further embodiments, materials with higher aspect ratios may be used if colloids with higher resistance but local conductivity are desired including, for example, to form films for use as transparent EMI shields for applications in architectural coatings such as window films.

In some embodiments, where the conductive material has a percolation threshold, the fraction of the conductive material in the colloid may exceed the percolation threshold. Above this threshold, a film formed from the colloid will exhibit global conductivity. Percolation thresholds can be calculated as described, for example, in Park et al., IEEE Transactions on Nanotechnology, 2010, 9:464-469.

In one or more embodiments, a dispersion medium includes one or more polyaramides, a dispersed phase includes a conductive material, the conductive material is a silver nanowire, and the weight/weight % of silver nanowire to the polyaramide(s) is between 1 and 100, between 1 and 80, between 1 and 70, between 1 and 60, between 1 and 50, or between 5 and 50, where weight/weight % is calculated by dividing the weight of the conductive material by the weight of the polyaramide(s).

In one or more embodiments, a dispersion medium includes one or more polyaramides, a dispersed phase includes a conductive material, the conductive material is a silver nanowire, and the volume % of silver nanowire to the polyaramide(s) is between 0.1 and 15, between 0.5 and 15, between 0.3 and 15, between 0.3 and 10, between 0.1 and 10, or between 0.5 and 10, where volume % is calculated by dividing the volume of the silver nanowires by the volume of the silver nanoparticles and the volume of the polyaramide(s).

In many embodiments, a film may be formed from a colloid that includes a conductive material in the dispersed phase. In one aspect, the film may have a thickness in a range from 100 to 2000 micrometers, from 100 nm to 200 micrometers, or from 100 nm to 1 micrometer.

In some embodiments, the film can be disposed on a substrate. The substrate can be an optical element. In other embodiments, the film can be a standalone film.

In some embodiments, the film can have a reflectance value of between 1% and 20%, 5% and 15%, or 5% and 10%. In some embodiments the reflectance value is less than 20%, less than 15%, less than 12%, less than 10%, less than 8%, or less than 7%.

In some embodiments, the film can have a sheet resistance value of less than 1000 Ω/square, less than 500 Ω/square, less than 100 Ω/square, less than 50 Ω/square, less than 40 Ω/square, less than 30 Ω/square, less than 20 Ω/square, less than 10 Ω/square, less than 5 Ω/square. In other embodiments, the film can have a sheet resistance value of greater than 1000 Ω/square, greater than 10,000 Ω/square, or greater than 100,000 Ω/square. Materials with lower sheet resistance values may be used, for example, to form films for touch panel displays or as electrodes for organic light-emitting diodes (OLEDs) and solar cells. Materials with higher sheet resistance values may be used, for example, to form films for use as transparent EMI shields.

In some embodiments, the film can have a visible light transmittance value of less than 40%, or less than 50%. In other embodiments, the film can have a visible light transmittance value of at least 80%, of at least 85%, of at least 90%, of at least 95%, or of at least 98%. Films with lower transmittance may be suitable for use as, for example, EMI shields. Films with higher transmittance may be used, for example, in touch panel displays.

In some embodiments, the dispersion medium of the film can have a refractive index value in a range from 1.4 to 2.5, or of 1.5 to 2.5, 2.2 to 2.5, or of 1.5 to 1.7.

In many embodiments, a film is formed by coating the colloid that includes a conductive material onto a substrate. In some embodiments, the conductive material in the film can be substantially aligned or parallel extending along an alignment direction. For example, coating a colloid containing poly(2,2′-disulfo-4,4′-benzidine terephthalamide) by any type of shear coating can align the polyaramide molecules in more or less the same direction over a macroscopic dimension and can further align the conductive material, for example, silver nanowires, in the dispersed phase. In some embodiments, the coating can be formed by shear coating the colloid onto a substrate to form a colloid layer. In some embodiments, the coating can be formed by spin-coating the colloid onto a substrate to form a colloid layer. In some embodiments, the coating can be formed, by spray coating the colloid onto a substrate to form a colloid layer. In some embodiments, the colloid can be printed or sprayed onto a substrate to form a colloid layer. In further embodiments, the colloid can placed in a mold. In some embodiments, the printing can be, for example, screen printing or flexographic printing. The viscosity of the colloid may be adjusted to optimize formation of the colloid layer, depending on the coating methods and, if applicable, the shear rate during coating.

In some embodiments, forming a film by coating the colloid may further include removing an aqueous solvent from the colloid layer. A solvent may be removed by the method of coating or by, for example, heating or spinning the film. In some embodiments, after the film is formed the film may be removed from the substrate to form, for example, a standalone film.

### Wavelength-Converting Materials

In one or more embodiments, the dispersed phase includes a wavelength-converting material. In some embodiments, the wavelength-converting material includes a down-converting material. The down converting material can be, for example, at least one of a phosphor or quantum dots. In some embodiments, the wavelength-converting material includes an up-converting material. The up-converting material can be, for example, Yb³⁺ and Ho³⁺ co-doped Y₂BaZnO₅ or Gd₂BaZnO₅ (Etchart et al., J. Mater. Chem., 2011, 21:1387-1394), up-converting nanocrystals, and/or up-converting nanoparticles.

In some embodiments, the wavelength-converting material may be symmetrical, for example, spherical particles, etc. In some embodiments, the wavelength-converting material may be anisometric including, for non-spherical particles or non-symmetrical particles. In some embodiments, anisometric wavelength-converting materials may have an aspect ratio of between 1.1 and 100, between 1.1 and 50, between 1.1. and 25, between 1.1 and 20, between 2 and 100, between 3 and 100, between 5 and 100, between 5 and 50, or between 5 and 20.

In some embodiments, a dispersion medium includes one or more polyaramides, a dispersed phase includes a wavelength-converting material, the wavelength-converting material includes a phosphor, and the weight/weight % of phosphor to the polyaramide(s) is between 50 and 300, between 50 and 250, between 50 and 220, between 50 and 200, between 100 and 300, between 150 and 300, between 180 and 300, between 200 and 300, or between 180 and 220, where weight/weight % is calculated by dividing the weight of the phosphor by the weight of the polyaramide(s).

In some embodiments, the volume % of phosphor to the polyaramide(s) is between 10 and 50, between 10 and 47, between 10 and 45, between 20 and 50, between 30 and 50, between 35 and 50, between 20 and 45, between 30 and 45, between 35 and 45, or between 35 and 45, where volume % is calculated by dividing the volume of the phosphor by the volume of the phosphor and the volume of the polyaramide(s).

In some embodiments, a dispersion medium includes one or more polyaramides, a dispersed phase includes a wavelength-converting material, the wavelength-converting material includes quantum dots, and the weight/weight % of quantum dots to the polyaramide(s) is between 0.1 and 10, between 0.1 and 8, between 0.1 and 6, between 0.1 and 4, between 0.1 and 3, between 0.1 and 2, between 0.2 and 10, between 0.4 and 10, between 0.5 and 10, between 0.5 and 5, or between 0.5 and 2.

In some embodiments, the volume % of quantum dots to the polyaramide(s) is between 0.02 and 3, between 0.02 and 2, between 0.02 and 1.5, between 0.02 and 1, between 0.02 and 0.75, between 0.02 and 0.6, between 0.05 and 3, between 0.07 and 3, between 0.1 and 3, or between 0.1 and 0.6.

In many embodiments, a film may be formed from a colloid that includes a wavelength-converting material in the dispersed phase. In one aspect, the film may have a thickness in a range from 100 to 2000 micrometers, from 100 nm to 200 micrometers, or from 100 nm to 1 micrometer.

In some embodiments, the film can be disposed on a substrate. The substrate can be an optical element. In other embodiments, the film can be a standalone film.

In some embodiments, the film can have a reflectance value of between 1% and 20%, 5% and 15%, or 5% and 10%. In some embodiments the reflectance value is less than 20%, less than 15%, less than 12%, less than 10%, less than 8%, or less than 7%.

In some embodiments, the dispersion medium of the film can have a refractive index value in a range from 1.4 to 3.0, from 1.4 to 2.5, from 1.5 to 2.5, or from 2.2 to 2.5.

In many embodiments, a film is formed by coating the colloid that includes a wavelength-converting material onto a substrate. In some embodiments, the wavelength-converting material in the film can be substantially aligned or parallel extending along an alignment direction. For example, coating a colloid containing poly(2,2′-disulfo-4,4′-benzidine terephthalamide) by any type of shear coating can align the polyaramide molecules in more or less the same direction over a macroscopic dimension and can further align the wavelength-converting material, for example, an anisometric material, in the dispersed phase. In some embodiments, the coating can be formed by shear coating the colloid onto a substrate to form a colloid layer. In some embodiments, the coating can be formed by spin-coating the colloid onto a substrate to form a colloid layer. In some embodiments, the coating can be formed, by spray coating the colloid onto a substrate to form a colloid layer. In some embodiments, the colloid can be printed or sprayed onto a substrate to form a colloid layer. In further embodiments, the colloid can placed in a mold. In some embodiments, the printing can be, for example, screen printing or flexographic printing. The viscosity of the colloid may be adjusted to optimize formation of the colloid layer, depending on the coating methods and, if applicable, the shear rate during coating.

In some embodiments, forming a film by coating the colloid may further include removing an aqueous solvent from the colloid layer. A solvent may be removed by the method of coating or by, for example, heating or spinning the film. In some embodiments, after the film is formed the film may be removed from the substrate to form, for example, a standalone film.

### Light Diffusing Material

In one or more embodiments, the dispersed phase includes light diffusing material. In some embodiments, the light diffusing material can include light diffusing particles including, for example, spherical particles, non-spherical particles, flakes, etc. The light diffusing material can include, for example, quartz, polymer, fumed silica, silicon dioxide, titanium dioxide, aluminum oxide, calcium carbonate, zinc sulfide, zinc oxide, antimony oxide, calcium carbonate, barium sulfate, glass, etc. The glass can include, for example, glass beads. The polymer can include for example, polystyrene, polycarbonate, styrene acrylonitrile copolymer, polypropylene, polymethyl methacrylate, etc.

In some embodiments, the light diffusing material may be symmetrical, for example, spherical particles, beads, etc. In some embodiments, the light diffusing material may be anisometric including, for non-spherical particles or non-symmetrical particles. In some embodiments, anisometric light diffusing material may have an aspect ratio of between 1.1 and 100, between 1.1 and 50, between 1.1. and 25, between 1.1 and 20, between 2 and 100, between 3 and 100, between 5 and 100, between 5 and 50, or between 5 and 20.

In some embodiments, a dispersion medium includes one or more polyaramides, a dispersed phase includes light diffusing material, and the weight/weight % of light diffusing material to the polyaramide(s) is between 6 and 600, between 6 and 500, between 6 and 400, between 6 and 300, between 6 and 250, between 6 and 200, between 7 and 600, between, 8 and 600, between 9 and 600, between 10 and 600, between 8 and 400, or between 10 and 200, where weight/weight % is calculated by dividing the weight of the phosphor by the weight of the polyaramide(s).

In some embodiments, the volume % of light diffusing material to the polyaramide(s) is between 1 and 99, between 3 and 90, between 3 and 80, between 3 and 60, between 3 and 50, between 10 and 90, between 10 and 80, between 10 and 60, or between 10 and 50, where volume % is calculated by dividing the volume of the light diffusing material by the volume of the light diffusing material and the volume of the polyaramide(s).

In many embodiments, a film may be formed from a colloid that includes light diffusing material in the dispersed phase. In one aspect, the film may have a thickness in a range from 100 to 2000 micrometers, from 100 nm to 200 micrometers, or from 100 nm to 1 micrometer.

In some embodiments, the film can be disposed on a substrate. The substrate can be an optical element. In other embodiments, the film can be a standalone film.

In some embodiments, the film can have a reflectance value of between 1% and 20%, 5% and 15%, or 5% and 10%. In some embodiments the reflectance value is less than 20%, less than 15%, less than 12%, less than 10%, less than 8%, or less than 7%.

In some embodiments, the film can have a haze value in a range from 10% to 90%. In one or more embodiments, the film can have a haze value in a range from 10% to 30%. Films with haze values in this range may be used, for example, for fine diffusers as found, for example, in the backlight of a display. In one or more embodiments, the film can have a haze value in a range from 60% to 90%. Films with haze values in this range may be used, for example, for coarse diffusers as found, for example, in the backlight of a display.

In some embodiments, the film can have a visible light transmittance value in a range from 10% to 90%. In some embodiments, the visible light transmittance value is greater than 80%, greater than 85%, greater than 88%, greater than 90%. In some embodiments, the visible light transmittance value is between 70% and 90%. In some embodiments, the visible light transmittance value is between 10% and 40%.

In some embodiments, the dispersion medium of the film can have a refractive index value in a range from 1.4 to 3.0, from 1.5 to 2.5, or from 1.5 to 1.7.

In many embodiments, a film is formed by coating the colloid that includes a light diffusing material onto a substrate. In some embodiments, the light diffusing material in the film can be substantially aligned or parallel extending along an alignment direction. For example, coating a colloid containing poly(2,2′-disulfo-4,4′-benzidine terephthalamide) by any type of shear coating can align the polyaramide molecules in more or less the same direction over a macroscopic dimension and can further align the light diffusing material, for example, an anisometric material, in the dispersed phase. In some embodiments, the coating can be formed by shear coating the colloid onto a substrate to form a colloid layer. In some embodiments, the coating can be formed by spin-coating the colloid onto a substrate to form a colloid layer. In some embodiments, the coating can be formed, by spray coating the colloid onto a substrate to form a colloid layer. In some embodiments, the colloid can be printed or sprayed onto a substrate to form a colloid layer. In further embodiments, the colloid can placed in a mold. In some embodiments, the printing can be, for example, screen printing or flexographic printing. The viscosity of the colloid may be adjusted to optimize formation of the colloid layer, depending on the coating methods and, if applicable, the shear rate during coating.

In some embodiments, forming a film by coating the colloid may further include removing an aqueous solvent from the colloid layer. A solvent may be removed by the method of coating or by, for example, heating or spinning the film. In some embodiments, after the film is formed the film may be removed from the substrate to form, for example, a standalone film.

The present invention is illustrated by the following examples. It is to be understood that the particular examples, materials, amounts, and procedures are to be interpreted broadly in accordance with the scope and spirit of the invention as set forth herein.

### EXAMPLES

All reagents, starting materials and solvents used in the following examples were purchased from commercial suppliers (such as Sigma-Aldrich Chemical Company, St. Louis, Mo.) and were used without further purification unless otherwise indicated.

Unless otherwise indicated, all percentages indicate weight percents.

### Example 1

In this Example, silver nanowires were suspended in poly(2,2′-disulfo-4,4′-benzidine terephthalamide-isophthalamide) (Formula X) and were coated roll-to-roll on PET to form globally conductive films.

Poly(2,2′-disulfo-4,4′-benzidine terephthalamide-isophthalamide), sodium form, was prepared as described in Example 11.

Silver nanowires were 20-25 nm in diameter and 19-20 μm in length with polyvinylpyrrolidone surface modifier.

PET (Melinex 453, Dupont Teijin Films) was used as a substrate and prepared in a two-step process. First, the PET was corona treated at a rate of 3 meters/min with an in-line treater (ISI CH-2KT+TRC, Integrated Solutions Co., Huntington Beach, Calif.) at 2 A. Second, the PET was primed with Primer (A-131-X, Mica Corporation, Shelton, Conn.). The primer was prepared to 0.5% solids by weight in de-ionized (DI) water and filtered through a nylon 0.45 μm filter. Primer was coated on the PET by slot die to a wet weight of 7 g/m² and dried for the equivalent of 1 minute in a 80° C. hot air oven.

A solution of poly(2,2′-disulfo-4,4′-benzidine terephthalamide-isophthalamide) (7% in water) was mixed with silver nanowires (1% in water) in 1:1 weight ratio on a bottle roller for 1 hour to form a suspension. The suspension was coated by microgravure (Mini-labo Coater, Yasui Seiki Co., Ltd., Tokyo) or slot die (Premier Fixed Slot Coating Die, Nordson Extrusion Dies Industries, LLC, Chippewa Falls, Wis.) on top of the primed PET to wet coat weights of 2.5-12.5 g/m². The coated layer was dried for the equivalent of 1 minute in a 80° C. hot air oven to remove water from the colloid.

The dried coating was passivated with the use of 10% strontium chloride water solution. Typical passivation process is as follows. Coated substrate was dipped into the passivation solution for 5 seconds so that the entire coated area was submerged. Then the sample was dipped into deionized water for 5 seconds. After that the sample was rinsed with a stream of deionized water then dried with compressed air with a flow rate of 30 m/s.

TABLE 1

| Thickness | Resistance | Total | Haze |
|---|---|---|---|
| nm | Ohm/sq | Transmittance % | % |
| 100 | 1 | 89.9 | 2.9 |
| 150 | 5 | 88.0 | 3.2 |
| 250 | 10 | 88.2 | 3.0 |
| 500 | 100 | 81.3 | 5.5 |

As shown in Table 1, electrical properties such as resistance and optical properties such as transmittance and haze can be controlled through varying film thickness. The films may be used for applications that require globally conductive transparent films such as touch panel displays.

### Example 2

In this Example, silver nanowires were suspended in poly(2,2′-disulfo-4,4′-benzidine terephthalamide-isophthalamide) (Formula X) and were coated using roll-to-roll slot die on PET to form locally conductive films.

PET substrate and coating solution were prepared as described in Example 1. Coating was done by slot die to wet coat weights of 15-20 g/m² and dried for the equivalent of 2 minutes in a 80° C. hot air oven to remove water from the colloid. Films were passivated and then analyzed as described in Example 1.

TABLE 2

| Thickness | Resistance | Total | Haze |
|---|---|---|---|
| nm | Ohm/sq | Transmittance % | % |
| 600 | ∞ | 79.3 | 7.1 |
| 750 | ∞ | 77.3 | 9.4 |

As shown in Table 2, these films do not have global conductivity. The films do, however, have local conductivity and are effective for use as transparent EMI shields for applications in architectural coatings such as window films.

For films in which global conductivity is not required, films with higher transmittance may be achieved by lowering the conductive nanowire loading below the percolation threshold. For silver nanowires, the percolation threshold is dependent on the aspect ratio. For example, silver nanowires having an aspect ratio of 100 have a percolation threshold of about 9.8% in poly(2,2′-disulfo-4,4′-benzidine terephthalamide-isophthalamide); silver nanowires having an aspect ratio of 500 have a percolation threshold of about 2.63% in poly(2,2′-disulfo-4,4′-benzidine terephthalamide-isophthalamide); silver nanowires having an aspect ratio of 1000 have a percolation threshold of about 0.46% in poly(2,2′-disulfo-4,4′-benzidine terephthalamide-isophthalamide). For Examples 1 and 2, the percolation threshold is about 0.46%.

### Example 3

In this Example, silver nanowires were suspended in poly(2,2′-disulfo-4,4′-benzidine terephthalamide-isophthalamide) (Formula X) and were coated using roll-to-roll slot die on PET to form films on a carrier substrate that can be released after processing to serve as a standalone conductive film.

Poly(2,2′-disulfo-4,4′-benzidine terephthalamide-isophthalamide), sodium form, was prepared as described in Example 11.

Silver nanowires were 20-25 nm in diameter and 19-20 μm in length with polyvinylpyrrolidone surface modifier.

PET (Melinex 453, Dupont Teijin) was used as a carrier film. A suspension containing 10% poly(2,2′-disulfo-4,4′-benzidine terephthalamide-isophthalamide) and 10% silver nanowires was mixed on a bottle roller for 1 hour. Coating was done by slot die (Premier Fixed Slot Coating Die, Nordson Extrusion Dies Industries, LLC, Chippewa Falls, Wis.) on top of the PET carrier to wet coat weights of 100-800 g/m². The coated layer was dried for the equivalent of 10 minutes in a 80° C. hot air oven to remove water from the colloid and passivated with the use of 10% strontium chloride water solution as described in Example 1. Then, the coating was released from the PET carrier film resulting in a standalone diffusing film. The resulting film was 40 μm thick, with 0% transmittance, 70% haze, and a sheet resistance value of 50 Ω/square. These parameters are tunable through conductive particle loading and film thickness.

As shown in this Example, thicker films (for example, 10-100 μm thick) can be released from a substrate after processing to serve as a standalone conductive film.

### Example 4

In this Example, silver nanowires were suspended in poly(2,2′-disulfo-4,4′-benzidine terephthalamide) (Formula I) and were coated using spin coating or using a bar applicator.

Poly(2,2′-disulfo-4,4′-benzidine terephthalamide) was prepared as described Example 12.

Silver nanowires were 20-25 nm diameter and 19-20 μm in length with polyvinylpyrrolidone surface modifier.

For spin coating, glass substrate was prepared by first ultra-sonicating in acetone for 5 minutes then ultra-sonicating in isopropyl alcohol for 5 minutes. The cleaned glass was rinsed with deionized water and dried by blowing with nitrogen gas. The coating suspension was prepared by mixing a solution of poly(2,2′-disulfo-4,4′-benzidine terephthalamide) (10% in water) with silver nanowires (1% in water) in a 1:9 weight ratio in an ultra-sonicator for 10 minutes. Spin coating was performed on a spin coater (Model P6700, Specialty Coating System Inc., Indianapolis, Ind.) at 700 rpm for 30 seconds.

For bar applicator coating, glass substrate was prepared by hand washing in an alkaline detergent. The cleaned glass was rinsed with deionized water and dried by blowing with compressed air. The coating suspension was prepared by mixing a solution of poly(2,2′-disulfo-4,4′-benzidine terephthalamide) (13.6% in water) with silver nanowires (1% in water) in a 1:2 weight ratio on vortexer for 5 minutes. The suspension was coated onto the glass substrate using a bar applicator (Model 5363, BYK-Gardner, Geretsried, Germany) set to a 50 μm gap.

The coatings were passivated with the use of 10% strontium chloride water solution as described in Example 1.

Film thickness was measured with a profilometer (Dektak 3ST, Veeco, Plainview, N.Y.) and anisotropy was qualitatively assessed with microscopy (OMAX M837PL). Total transmittance was measured with a spectrophotometer (UV-2600, Shimadzu, Kyoto, Japan) and global film conductivity was verified with a DC voltmeter with probes ˜1 mm apart.

TABLE 3

| Coating | | |
|---|---|---|
| Technique | Spin Coating | Bar Applicator |
| Thickness, nm | 200 | 1000 |
| Resistance, | 440 | <1000 |
| Ohm/sq | | |
| Transmittance, % | 84% | 72% |

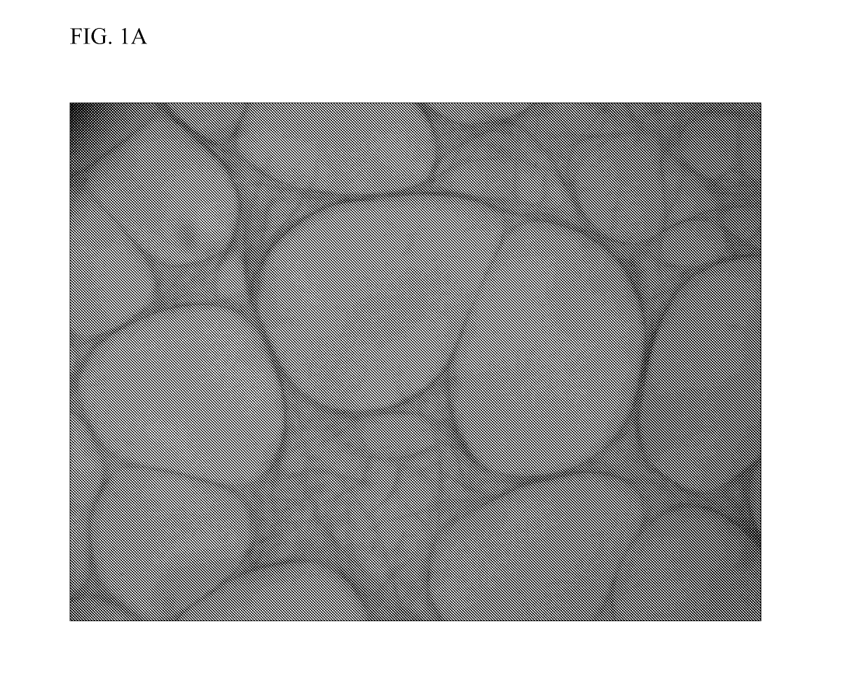

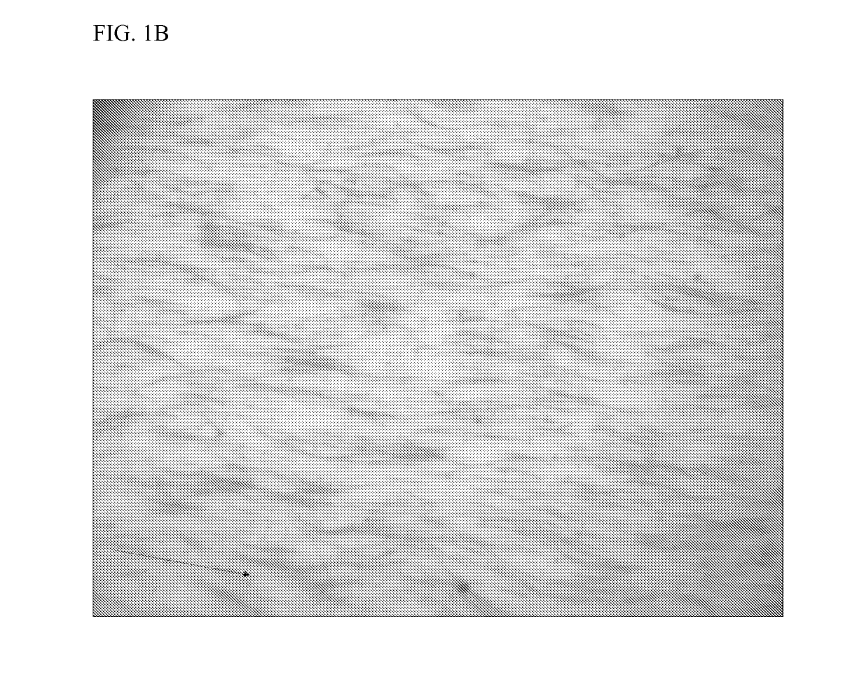

As shown in Table 3 and FIG. 1, shear coated poly(2,2′-disulfo-4,4′-benzidine terephthalamide), a lyotropic liquid crystal solution of rod-like polymeric molecules, permits nano-dispersant two-dimensional structure and anisotropy to be controlled.

### Example 5

In this Example, phosphor was suspended in poly(2,2′-disulfo-4,4′-benzidine terephthalamide-isophthalamide) (Formula X) and coated on cellulose triacetate film (TAC) by bar applicator.

Poly(2,2′-disulfo-4,4′-benzidine terephthalamide-isophthalamide), sodium form, was prepared as described in Example 11. Poly(2,2′-disulfo-4,4′-benzidine terephthalamide-isophthalamide), sodium form, reflection spectra were collected at various incident angles using a spectrophotometer (UV-2600, Shimadzu, Kyoto, Japan). Then, refractive index was calculated using the Fresnel formulae.

Yttrium aluminium garnet based yellow phosphor particles were used, with peak wavelength 558 nm, CIEx 0.444, CIEy 0.536, and median diameter of the cumulative volume distribution of 8.5 μm.

Saponified TAC was used as a substrate. A solution of poly(2,2′-disulfo-4,4′-benzidine terephthalamide-isophthalamide) (7.6% in water) was mixed with water-soluble polyester (35% in water) in 5:1 weight ratio on a bottle roller for 15 minutes. Phosphor particles were added to 6%, 11%, and 16%, based on total suspension weight. The suspensions were rolled on a bottle roller for 1 hour. Coating was done by bar applicator (Model ZUA 2000, Zehntner Testing Instruments, Sissach, Switzerland) with gap size adjusted 100-500 μm. The coated layer was dried in a 70° C. oven. The coated films were laminated to another piece of TAC with optically clear adhesive (3M™ Optically Clear Adhesive 8142KCL, St. Paul, Minn.). Color temperature was measured with an integrating sphere lumens measurement system (SM-2000, Optimum Optoeletronies Corp, Taiwan) under 467 nm light excitation.

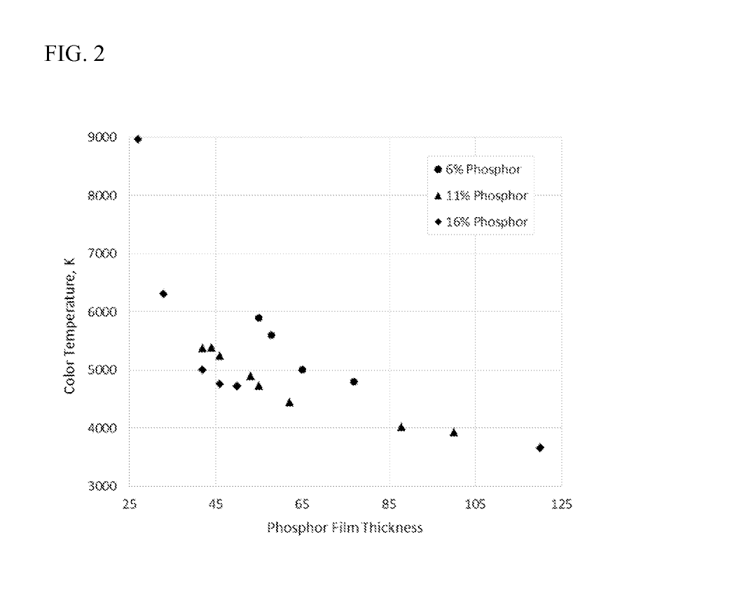

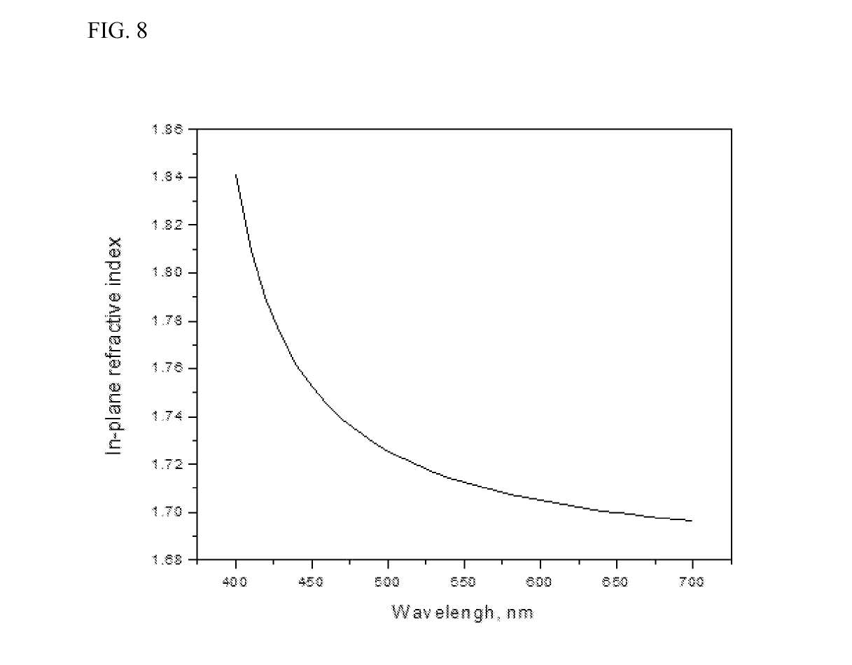

As shown in FIG. 8, poly(2,2′-disulfo-4,4′-benzidine terephthalamide-isophthalamide) has high refractive index that can closely match the refractive index of the suspended phosphor particles. As shown in FIG. 2, color temperature can be controlled by altering film thickness and phosphor loading.

### Example 6

In this Example, quantum dots were suspended in poly(2,2′-disulfo-4,4′-benzidine terephthalamide-isophthalamide) (Formula X) and then coated on glass by bar applicator.

Poly(2,2′-disulfo-4,4′-benzidine terephthalamide-isophthalamide), sodium form, was prepared as described in Example 11.

Green and red quantum dot materials had CdSe or CdSSe cores with a ZnS shell and a polymeric coating containing carboxylic acid reactive groups (Zeta potential −30 to −50 mV, emission wavelengths 580 nm and 645 nm).

Glass substrate was prepared by hand washing in an alkaline detergent. The cleaned glass was rinsed with deionized water and dried by blowing with compressed air. The coating suspension was prepared by mixing a solution of poly(2,2′-disulfo-4,4′-benzidine terephthalamide-isophthalamide) (1% in water) with quantum dots (8 μM in water) in a 99:1 weight ratio on vortexer for 5 minutes. Coatings were formed using a bar applicator (Model 5363, BYK-Gardner, Geretsried, Germany) set to varying gaps 12-150 μm, and the wet coatings were dried in an 70° C. oven for 10 minutes. The resulting dried films were 0.1-1.0 μm thick.

### Example 7

In this Example, quantum dots were suspended in poly(2,2′-disulfo-4,4′-benzidine terephthalamide-isophthalamide) (Formula X) and cast into the form of an optical element.

Quantum dots had CdSSe core, ZnS shell, with polymeric coating containing carboxylic acid reactive groups (Zeta potential −30 to −50 mV, emission wavelength 645 nm).

Poly(2,2′-disulfo-4,4′-benzidine terephthalamide-isophthalamide), sodium form, was prepared as described in Example 11.

A suspension of poly(2,2′-disulfo-4,4′-benzidine terephthalamide-isophthalamide) and water-based quantum dots was mixed on a bottle roller for 1 hour. The suspension, which contained 7.0% poly(2,2′-disulfo-4,4′-benzidine terephthalamide-isophthalamide) and 0.1% quantum dots by weight in de-ionized water, was cast into a lens-shaped mold. The mold was placed in a 50° C. drying oven and until set and the resulting quantum dot suspended lens was removed from the mold.

### Example 8

In this Example, diffuser particles were suspended in a high refractive index polymeric solution spray and then coated on a substrate.

Poly(2,2′-disulfo-4,4′-benzidine terephthalamide) (Formula I) was prepared as described in Example 12.

Glass (0.7 mm thick) prepared as described in Example 6 was used as a substrate. PMMA (1 mm thick) was also used as a substrate and prepared with plasma treatment (oxygen plasma with 800W power at 200 mm/s speed) and primer coating, as described in Example 1. The coating suspension was prepared by mixing a solution of poly(2,2′-disulfo-4,4′-benzidine terephthalamide) (7.4% in water) with fumed silica particles (specific surface area 380 m²/g and refractive index n=1.47) to 1% and 2% loadings. The suspensions were mixed on a bottle roller for 1 hour. Spray coating was performed using Spray Coating Equipment (RSM-500FR, Rasem Technologoy Co., LTD., New Taipei City, Taiwan (R.O.C.)). Spray coating was done with varying parameters to create diffusing films with different thicknesses and optical properties. Spray pressure was varied from 20 to 60 psi, flow rate was varied from 1.1 to 2.7 g/min, and nozzle speed was varied from 65 to 500 mm/s. Similar results were obtained with glass and PMMA substrates.

TABLE 4

| silica | thickness | haze | transmittance |
|---|---|---|---|
| loading, % | on glass, um | % | total, % |
| 1% | 1.7 | 72 | 83 |
| 2% | 1.7 | 82 | 79 |
| 2% | 6.4 | 88 | 53 |

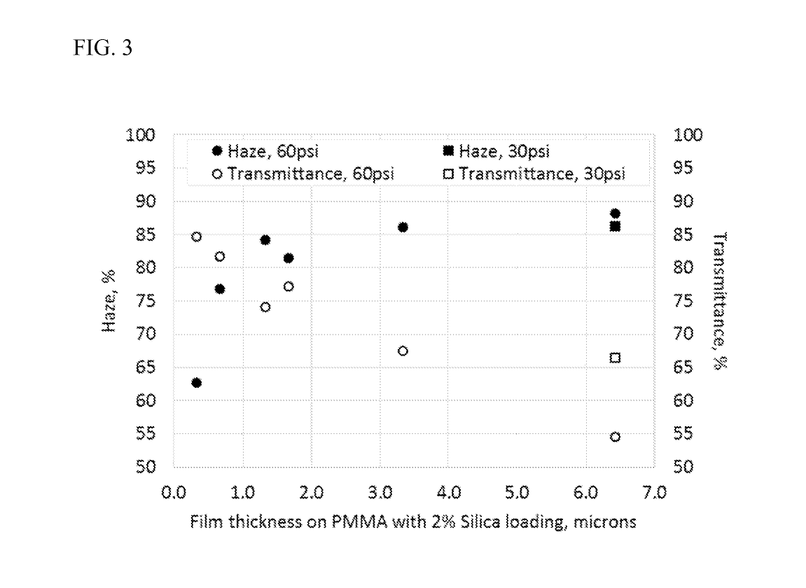

As shown in Table 4 and FIG. 3, haze and transmittance values can be optimized by varying the diffusing particle loading in the suspension, the spray pressure, and the coated diffusing layer thickness.

### Example 9

In this Example, diffuser particles were suspended in a high refractive index polymeric solution and the polymeric solution was used to form a standalone film.

Poly(2,2′-disulfo-4,4′-benzidine terephthalamide-isophthalamide), sodium form, was prepared as described in Example 11.

PET (Melinex 453, Dupont Teijin) was used as a carrier film. A suspension containing 13% poly(2,2′-disulfo-4,4′-benzidine terephthalamide-isophthalamide) (Formula X) and 1% PMMA beads (10 μm) was mixed on a bottle roller for 1 hour. Coating was done by slot die (Premier Fixed Slot Coating Die, Nordson Extrusion Dies Industries, LLC, Chippewa Falls, Wis.) on top of the PET carrier to wet coat weights of 100-800 g/m². The coated layer was dried in a hot air oven at 80° C. for 10 minutes and passivated with the use of 10% strontium chloride water solution as described in Example 1. Then, the coating was released from the PET carrier film resulting in a standalone diffusing film.

A standalone diffusing film of 100 μm had haze 75% and transmittance 55%. Similarly as in Example 8, the haze and transmittance values can be tuned based on diffuser particle loading and film thickness.

### Example 10

In this Example, rheological properties of solutions of poly (2,2′-disulfo-4,4′-benzidine terephthalamide-isophthalamide) (Formula X) and poly(2,2′-disulfo-4,4′-benzidine terephthalamide) (Formula I) at various % solids in water were studied with use of a rheometer (AR 2000, TA Instruments, New Castle, Del.).

Poly(2,2′-disulfo-4,4′-benzidine terephthalamide-isophthalamide), sodium form, was prepared as described in Example 11.

Poly(2,2′-disulfo-4,4′-benzidine terephthalamide) (Formula I) was prepared as described in Example 12.

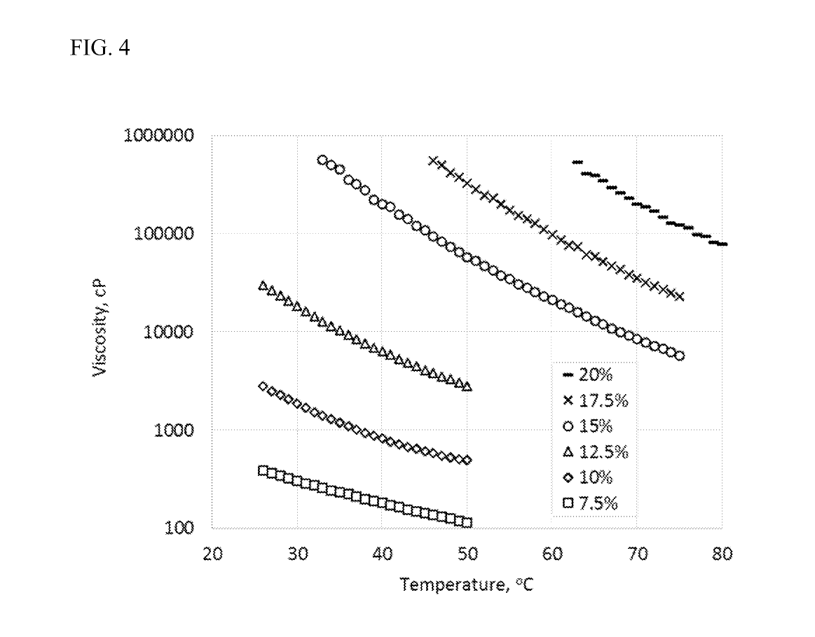

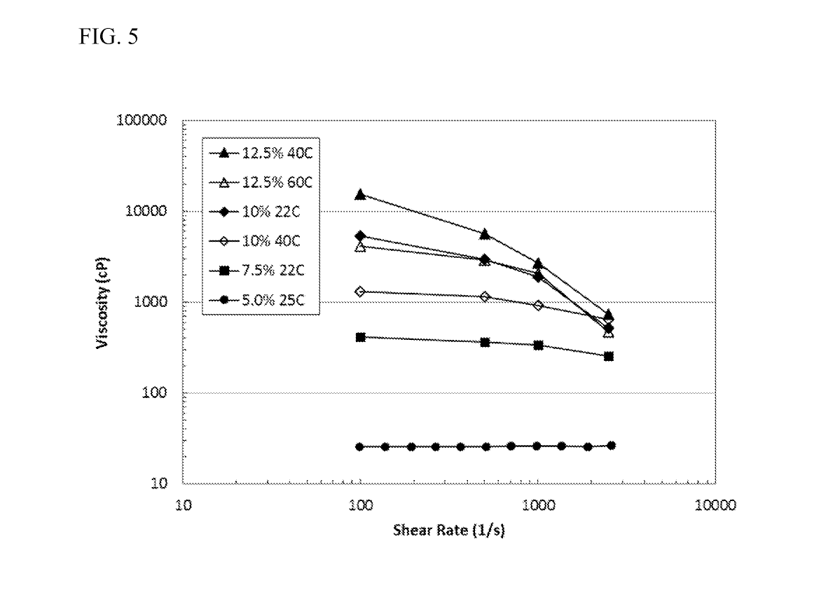

As shown in FIG. 4, modifications to solutions of poly(2,2′-disulfo-4,4′-benzidine terephthalamide-isophthalamide) in water can be used to control suspension stability since the viscosity is highly sensitive to polymer solids content, temperature, and shear rate. At the low shear rates that are experienced during storage conditions, for example 100 l/s and lower, viscosity is highly sensitive to solids content; thus, solids contents can be optimized to improve suspension stability. During formation of the colloid layer, different coating methods require different viscosities and apply different shear rates. For example, a slot die coating is optimal with suspension viscosity 1000 cP and lower, and applies shear rates to the coating suspension around 2000 l/s. As seen in FIG. 5, the suspension medium is shear thinning so suspensions are stable while stored, but suspensions may also be coated by slot die due to the shear thinning behavior.

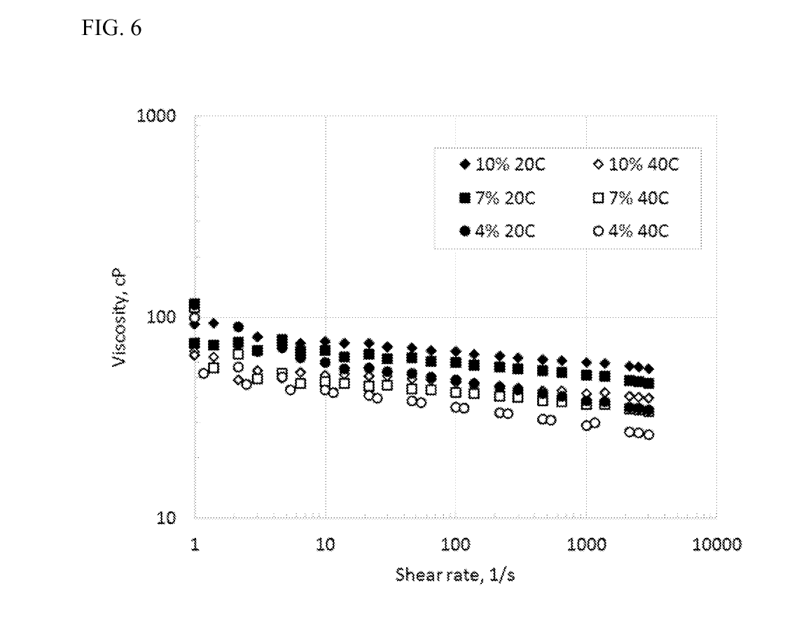

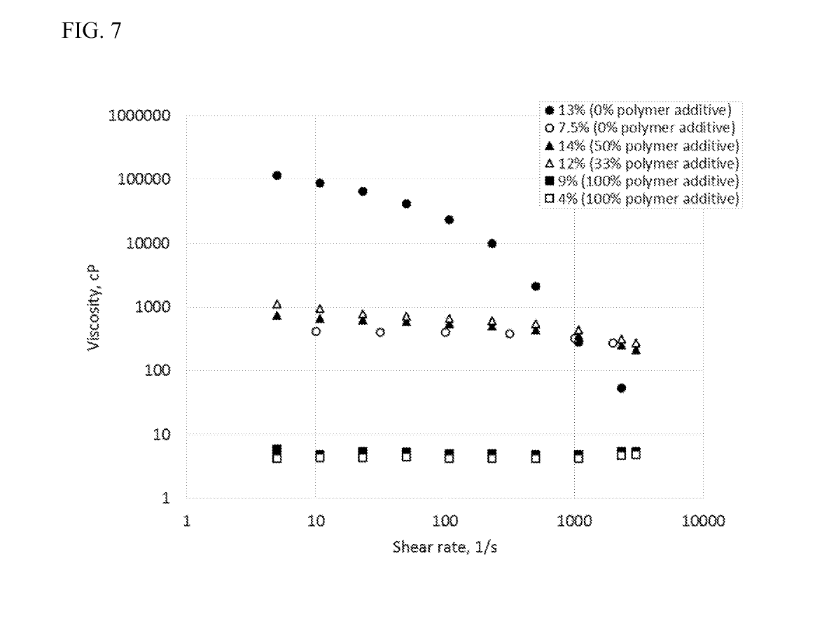

FIG. 6 shows the dependence of poly(2,2′-disulfo-4,4′-benzidine terephthalamide) viscosity on solids content and temperature versus shear rate. FIG. 7 shows the change in viscosity of poly(2,2′-disulfo-4,4′-benzidine terephthalamide-isophthalamide) with the addition of additives to the suspending medium, such as polyester, as described in Example 5.

### Example 11

The example describes synthesis of 2,2′-disulfo-4,4′-benzidine terephthalamide-isophthalamide copolymer sodium salt.

10.0 g (0.029 mot) of 4,4′-diaminobiphenyl-2,2′-disulfonic acid was mixed with 3.1 g (0.029 mol) of sodium carbonate and 160 ml of water and stirred until the solid completely dissolved. Then 50 ml of toluene was added. Upon stirring the obtained solution, a solution of 4.3 g (0.021 mol) of terephthaloyl chloride and 1.6 g (0.008 mol) of isophthaloyl chloride and 0.7 g (0.005 mol) of benzoyl chloride in 30 ml of toluene were added followed by addition of 3.4 g (0.033 mol) of sodium carbonate in 50 ml of water. The resulting mixture thickened in about 30 minutes. It was heated to boiling and toluene distilled out. The resulting water solution was ultrafiltered using a PES membrane with MW cut-off 5K Dalton. Yield of the copolymer was 200 g of 7% water solution.

Gel permeation chromatography (GPC) analysis of the sample was performed with Hewlett Packard 1260 chromatograph with diode array detector (λ=230 nm), using Varian GPC software Cirrus 3.2 and TOSOH Bioscience TSKgel G5000 PW_{XL} column and 0.2 M phosphate buffer (pH=7) as the mobile phase, Poly(para-styrenesulfonic acid) sodium salt was used as GPC standard. The calculated number average molecular weight, Mn, weight average molecular weight, Mw, and polydispersity, PD, were found as 5.3×10⁴, 1.6×10⁵, and 3.0 respectively.

### Example 12

This Example describes synthesis of poly(2,2′-disulfo-4,4′-benzidine terephthalamide) sodium salt.

10.0 g (0.029 mol) of 4,4′-diaminobiphenyl-2,2′-disulfonic acid was mixed with 3.1 g (0.029 mol) of sodium carbonate and 700 ml of water and stirred till dissolution. While stirring, the obtained solution a solution of 6.5 g (0.032 mol) of terephthaloyl chloride in 700 ml of toluene was added followed by a solution of 6.1 g of sodium carbonate in 100 g of water. The stirring was continued for 3 hours. Then the emulsion was heated to boiling and toluene distilled out. The resulting water solution was ultrafiltered using PES membrane with MW cut-off 20K Dalton, Yield of the polymer was 180 g of 8% water solution.

Gel permeation chromatography (GPC) analysis of the sample was performed with a Hewlett Packard 1260 chromatograph with diode array detector (λ=230 nm), using Varian GPC software Cirrus 3.2 and TOSOH Bioscience TSKgel G5000 PW_{XL} column and 0.2 M phosphate buffer (pH=7) as the mobile phase. Poly(para-styrenesulfonic acid) sodium salt was used as GPC standard. The calculated number average molecular weight, Mn, weight average molecular weight, Mw, and polydispersity, PD, were found as 1.1×10⁵, 4.6×10⁵, and 4.2 respectively.

The complete disclosure of all patents, patent applications, and publications cited herein are incorporated by reference. In the event that any inconsistency exists between the disclosure of the present application and the disclosure(s) of any document incorporated herein by reference, the disclosure of the present application shall govern. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

Unless otherwise indicated, all numbers expressing quantities of components, molecular weights, and so forth used in the specification and claims are to be understood as being modified in all instances by the term “about.” Accordingly, unless otherwise indicated to the contrary, the numerical parameters set forth in the specification and claims are approximations that may vary depending upon the desired properties sought to be obtained by the present invention. At the very least, and not as an attempt to limit the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. All numerical values, however, inherently contain a range necessarily resulting from the standard deviation found in their respective testing measurements.

All headings are for the convenience of the reader and should not be used to limit the meaning of the text that follows the heading, unless so specified.

1. A colloid comprising
a dispersion medium comprising a polyaramide comprising one or more of 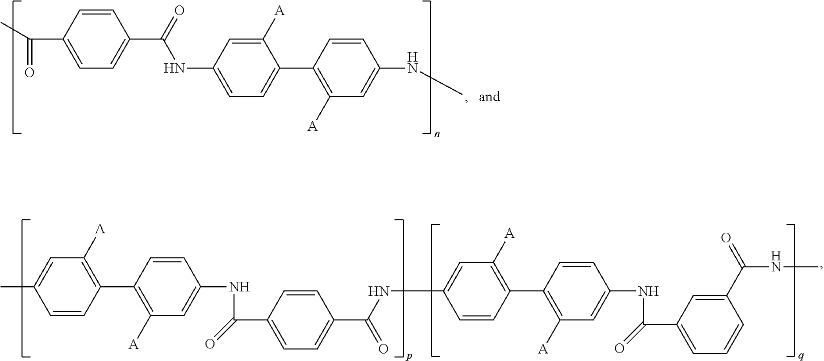
wherein A is independently selected from SO₃H or COOH, or a sulfonic or carboxy salt of an alkali metal, ammonium, quaternary ammonium, alkali earth metal, Al³⁺, La³⁺, Ce³⁺, Fe³⁺, Cr³⁺, Mn²⁺, Cu²⁺, Zn²⁺, Pb²⁺ or Sn²⁺; n is an integer between 2 and 10,000; p is an integer greater than or equal to 1; and q is an integer greater than or equal to 1; and
a dispersed phase comprising a wavelength-converting material comprising at least one of a phosphor or quantum dots.

2. (canceled)

3. (canceled)

4. (canceled)

5. (canceled)

6. (canceled)

7. (canceled)

8. (canceled)

9. The colloid of claim 1, wherein the wavelength-converting material comprises a phosphor and the weight/weight % of phosphor to the polyaramide is between 50 and 300.

10. The colloid of claim 1, wherein the wavelength-converting material comprises a phosphor and the volume % of phosphor to the polyaramide is between 10 and 50.

11. The colloid of claim 1, wherein the wavelength-converting material comprises quantum dots and further wherein the weight/weight % of quantum dots to the polyaramide is between 0.1 and 10.

12. The colloid of claim 1, wherein the wavelength-converting material comprises quantum dots and further wherein the volume % of quantum dots to the polyaramide is between 0.02 and 3.

13. The colloid of claim 1, wherein the dispersed phase further comprises light diffusing material and the light diffusing material comprises organic polymer, glass, quartz, fumed silica, silicon dioxide, titanium dioxide, aluminum oxide, calcium carbonate, zinc sulfide, zinc oxide, antimony oxide, or barium sulfate.

14. The colloid of claim 13, wherein the volume % of light diffusing material to the polyaramide is between 10 and 50.

15. The colloid of claim 13, wherein the weight/weight % of light diffusing material to the polyaramide is between 3 and 90.

16. The colloid of claim 13, wherein the dispersion medium is aqueous.

17. The colloid of claim 13, further comprising polyester.

18. The colloid of claim 17, wherein the weight/weight % of polyester to the polyaramide is between 50 and 100.

19. A film comprising the colloid of claim 1.

20. The film of claim 19, wherein the dispersed phase comprises anisometric material that is substantially aligned or parallel extending along an alignment direction.

21. (canceled)

22. (canceled)

23. (canceled)

24. The film of claim 19, wherein the film is disposed on an optical element.

25. (canceled)

26. (canceled)

27. (canceled)

28. (canceled)

29. (canceled)

30. (canceled)

31. The film of claim 19, wherein the dispersion medium of the film has a refractive index value in a range from 1.5 to 2.5.

32. The film of claim 31, wherein the dispersion medium of the film has a refractive index value in a range from 2.2 to 2.5.

33. The film of claim 19, wherein the film further comprises light diffusing material, and further wherein the film has a haze value in a range from 10% to 90%.

34. The film of claim 33, wherein the film has a haze value in a range from 10% to 30%.

35. The film of claim 33, wherein the film has a haze value in a range from 60% to 90%.

36. (canceled)

37. The film of claim 19, wherein the film further comprises light diffusing material, and the dispersion medium of the film has a refractive index value in a range from 1.5 to 2.5.

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)
